(19) United States
(12) Patent Application Publication
(10) Pub. No.: US 2007/0010148 A1
(43) Pub. Date: Jan. 11, 2007

(54) Cleanroom wiper

(76) Inventors: Lori Ann Shaffer, Alpharetta, GA (US); Ali Yahiaoui, Roswell, GA (US); Eugenio Go Varona, Marietta, GA (US)

Correspondence Address: KIMBERLY-CLARK WORLDWIDE, INC., 401 NORTH LAKE STREET, NEENAH, WI, 54956, US

(21) Appl. No.: 11/292,650

(22) Filed: Dec. 2, 2005

Related U.S. Application Data
(60) Provisional application No. 60/698,116, filed on Jul. 11, 2005.

(51) Int. Cl. B32B 5/02

(52) U.S. Cl. 442/59; 442/118; 442/164

(57) ABSTRACT

A wiper for use in a cleanroom environment made of a knitted, continuous synthetic filaments is disclosed. The wiper has a surfactant added to the surface of the knitted substrate. The wiper has improved wiping ability, low lint and low extractable ions making it suitable for use in critical cleanroom environments.

This application claims priority to U.S. Provisional Application No. 60/698,116, entitled “CLEANROOM WIPER” and filed on Jul. 11, 2005, in the names of Lori Ann Shaffer et al. which is incorporated herein by reference in its entirety.

Attention is drawn to a related application entitled “Cleanroom Wiper” in the names of Shaffer et al., Attorney Docket Number 21,772B which is incorporated herein by reference in its entirety.

### BACKGROUND

Cleanrooms are widely used for the manufacture, assembly and packaging of sensitive products and components where it is necessary for the various processes to be conducted in a controlled environment substantially free of particles and other potential contaminants. As such, cleanrooms are typically a confined environment in which humidity, temperature, and particulate matter are precisely controlled to protect the sensitive products and components from contamination by dirt, molds, viruses, noxious fumes and other potentially damaging particles.

Broadly defined, particles may be any minute object in solid or liquid state with clearly defined boundaries, i.e., a clearly defined contour. Such particles may be dust, human skin or hair, or other debris. On a relative order of magnitude, a human will regularly shed 100,000 to 5000,000 particles of a size of 0.3 micrometer or larger, per minute. In some environments, such particles may be microorganisms or viable particles (i.e., single-cell organisms capable of multiplication, at an appropriate ambient temperature, in the presence of water and nutrients). These viable particles may include bacteria, moulds, yeasts and the like. Particles may come from the outside atmosphere, air conditioning systems, and liberation within the cleanroom by processes or by those who use the room. Every article that is brought into the cleanroom brings with it the potential of introducing such contaminants into the room.

Cleanrooms are found in industries with sensitive products and components such as microchip manufacturing, LCD monitor manufacturing, sensitive electronics manufacturing, pharmaceuticals, and the like. For example, in microprocessor manufacturing, such micro-particles can destroy the circuitry of a wafer by interfering with the conductive layers on the wafer surface. Strict controls and standards have been devised and are used throughout such industries to certify the cleanliness of the cleanroom. The more critical the need for cleanliness, the less tolerance there is for particles within the cleanroom.

The classification of cleanrooms by the ISO standards is based on the maximum number of particles of a certain size that can be present. For example, in microchip manufacturing, the cleanrooms are generally certified as ISO Class 3 environments. An ISO Class 3 environment may only have a maximum of 8 particles per cubic meter that are 1 micrometer or larger; 35 particles per cubic meter that are 0.5 micrometers or larger; 102 particles per cubic meter that are 0.3 micrometer or larger; 237 particles per cubic meter that are 0.2 micrometer or larger; and a maximum of 1000 particles per cubic meter that are 0.1 micrometer or larger. ISO Class 4 and 5 environments allow for an incremental increase in the particles present in the cleanroom which may be appropriate for less critical manufacturing environments than is necessary in ISO Class 3 environments.

Wipers are commonly used in cleanrooms to clean surfaces and tools being introduced to the cleanroom, clean up spills and excess processing chemicals and debris, cover sensitive equipment, and to wipe down surfaces within the cleanroom. In the ISO Class 3 environments of microchip production, knit polyester wipers are commonly used. While a necessary part of the production processes, every wiper brought into the cleanroom environment has the potential of introducing potentially damaging particles into the cleanroom.

The first potential source of particles is lint from the wiper itself. The lint may be carried along with the wiper or may be generated from the wiper itself. Typically, for a knitted polyester wiper, lint is generated from the wiper edges where loose fragments of the polyester yarn are present due to the finishing processes used during the manufacture of the wiper. Sealing of the edges of the wiper, as is commonly done by the manufacturers of such wipers, helps alleviate much of this type of lint.

Another potential source of adverse contaminants is molecules or atoms in the form of ions or residues left on the wiper. These contaminants typically come from water used in processing the wipers, chemicals added to improve performance characteristics of the wiper, or human interaction with the wipers. For example, in the production of silicon wafers for microchip production, ions such as sodium (Na), potassium (K) and chloride (Cl) are commonly found in cleanroom wipers and can cause serious production problems and may damage the wafers being produced. For example, in microprocessor manufacturing, residual ions can destroy the circuitry on a wafer by sticking to the wafer surface and reacting with the materials used in creating the circuit.

Along with the potential of introducing particles into the cleanroom environment, another issue with the use of cleanroom wipers is related to cleaning up spills and excess liquids used in processing. As is well known, cellulosic and cotton fibers have been used in paper towels, rags, wipers and similar articles. Such articles work well to absorb large quantities of liquid, but they are not compatible with more stringent cleanroom environments. A woven cotton rag, a paper towel, or a wiper made of polyester-cellulose fibers has much higher amounts of lint than a cleanroom laundered, knitted polyester wiper. The tradeoff for reducing the amount of lint with the use of a knitted polyester wiper is a decrease in the amount of absorbent capacity (i.e., the maximum amount of liquid the wiper can hold) for such wipers.

Additionally, while typical knit polyester wipers manage to remove liquids from critical surfaces they often leave some degree of residue on the surfaces after wiping. For example, a surface wiped for one minute using a 6-gram polyester wiper with 6 grams of isopropyl alcohol, while the person wiping the surface wore an 8-gram nitrile glove, left behind 19.3 micrograms of residue (61 ng/cm²). Most of the residue was from the wiper and glove with a minimal amount being from the isopropyl alcohol. As discussed above, such residue can cause problems in sensitive manufacturing environments such as microchip production.

In the manufacture of certain synthetic wipers, surfactants have been added to the surface of the substrate to improve the ability of liquid to wet out on the surface, helping the wiper to quickly absorb the liquid. However, traditional surfactants produce residue and ions that can be harmful in the sensitive environments of cleanrooms, as discussed above.

### SUMMARY OF THE INVENTION

In view of the issues with lint and ions as well as the need to wipe surfaces dry in a critical cleanroom environment, it is desired to have a low-lint, low-ion, knitted cleanroom wiper with greater ability to wipe a surface dry.

The wipers of the present invention are capable of wiping a surface dry in a cleanroom environment. Such wipers are made of a knitted substrate of continuous, synthetic filaments and is suitable for use in a cleanroom environment. A surfactant is present on the surface of the knitted substrate and may be a gemini surfactant, a polymeric wetting agent, or a functionalized oligomer.

In various embodiments, the wiper may have and add-on amount of about 0.5 percent or less, by weight of the knitted substrate. Further, the add-on amount may be between about 0.06 percent and about 0.5 percent, by weight of the knitted substrate. In some embodiments, the wiper may have a vertical wicking capability at 60 second of about 5 centimeters or greater; a wipe dry capability of about 760 square centimeters or greater; and/or a dynamic wiping efficiency of about 91 percent or greater.

In some embodiments, the wiper may have an extractable ion content of less than about 0.5 parts per million of sodium (Na) ions, less than about 0.5 parts per million of potassium (K) ions, and less than about 0.5 parts per million of chloride (Cl) ions and/or have about 30×10⁶ particles per square meter or less, by the Biaxial Shake Test (IEST RP-CC004.3, Section 6.1.3).

In further embodiments, the wiper may have a knitted structure with a pore size distribution where about 5 to about 25 percent of the pores are of a size of about 20 microns or less, and where about 30 to about 50 percent of the pores are of a size in the range from about 60 microns to about 160 microns.

The present invention is also directed to a wiper for use in a cleanroom environment made of a knitted substrate of continuous, synthetic filaments and having a wipe dry capability of about 850 square centimeters or greater.

In various embodiments, a gemini surfactant, a polymeric wetting agent, or a functionalized oligomer may be present on the surface of the knitted substrate. In various other embodiments, the wiper may have a vertical wicking capability at 60 seconds of about 5 centimeters or greater; a dynamic wiping efficiency of about 91 percent or greater; or an extractable ion content of less than about 0.5 parts per million of Na ions, less than about 0.5 parts per million of K ions, and less than about 0.5 parts per million of Cl ions and about 30×10⁶ particles per square meter or less, by the Biaxial Shake Test (IEST RP—CC004.3, Section 6.1.3).

In other embodiments, the knitted substrate may be made of continuous polyester filaments or may have a knitted structure with a pore size distribution where about 5 to about 25 percent of the pores are of a size of about 20 microns or less, and where about 30 to about 50 percent of the pores are of a size in the range from about 60 microns to about 160 microns.

Finally, the present invention is also directed to a wiper for use in a cleanroom environment made of a knitted substrate of continuous, polyester filaments and having a surfactant present on the surface of the knitted substrate. The surfactant may be a gemini surfactant, a polymeric wetting agent, or a functionalized oligomer. Additionally, the wiper has an extractable ion content of less than about 0.5 parts per million of Na ions, less than about 0.5 parts per million of K ions, and less than about 0.5 parts per million of Cl ions. The wiper also has about 30×10⁶ particles per square meter or less, by the Biaxial Shake Test (IEST RP—CC004.3, Section 6.1.3).

In some embodiments, the surfactant may be present in an add-on amount of about 0.5 percent or less, by weight of the knitted polyester substrate. Further, the add-on amount of the surfactant may be between about 0.06 percent and about 0.5 percent, by weight of the knitted polyester substrate.

In various other embodiments the wiper may have a vertical wicking capability at 60 seconds of about 5 centimeters or greater, a wipe dry capability of about 850 square centimeters or greater; a dynamic wiping efficiency of about 91 percent or greater; and/or a pore size distribution where about 5 to about 25 percent of the pores are of a size of about 20 microns or less, and where about 30 to about 50 percent of the pores are of a size in the range from about 60 microns to about 160 microns.

### BRIEF DESCRIPTION OF THE DRAWINGS

FIG. 1 is a magnified, top view of a knitted polyester wiper having an interlock knit pattern.

FIG. 2 is a magnified, perspective view of the knitted polyester wiper of FIG. 1.

FIG. 3 is a magnified, top view of a knitted polyester wiper having a Swiss pique knit pattern.

FIG. 4 is a magnified, cross sectional view of the knitted polyester wiper of FIG. 3.

FIG. 5 is a magnified, top view of a knitted polyester wiper having a French pique knit pattern.

FIG. 6 is a magnified, cross sectional view of the knitted polyester wiper of FIG. 5.

FIG. 7 is a magnified, top view of a knitted polyester wiper having a French pique knit pattern with a loose stitch.

FIG. 8 is a magnified, top view of a knitted polyester wiper having a French pique knit pattern with a tight stitch.

FIG. 9 is a graph of the relative pore size distribution of the materials of FIGS. 7 and 8 as shown as the pore volume (in cubic centimeters per gram) versus the equivalent pore radius (in microns).

FIG. 10 is a schematic view of the testing apparatus for use with the vertical wicking test.

FIG. 11 is a perspective view of the testing apparatus for use with the wipe dry testing procedure.

FIG. 12 is a closer perspective view of the sample sled of the testing apparatus of FIG. 11.

FIG. 13 is a front view of the improved testing apparatus for use with the wipe dry testing procedure.

FIG. 14 is another front view of the improved testing apparatus for use with the wipe dry testing procedure.

FIG. 15 is a closer perspective view of the disc of the testing apparatus of FIGS. 13 and 14.

FIG. 16 is a perspective top view of the sample sled attached to the wiping arm assembly of the wipe dry testing apparatus.

FIG. 17 is a perspective top view of the sample sled for use in the wipe dry testing procedure.

FIG. 18 is a perspective bottom view of the sample sled for use in the wipe dry testing procedure.

### DETAILED DESCRIPTION

The wipers of the present invention have an improved ability to wipe a surface dry of a liquid to a greater degree than available knitted polyester wipers currently used in cleanroom environments. The present invention is able to achieve these improved wipe dry capability by multiple possible methods. The first general method is the modification of the surface of the knitted substrate material to improve the wipe is dry capability of the wiper. A second general method for improving the wipe dry capability is modification of the knitted fabric structure. Both of these general solutions are capable of providing the desired wipe dry capability individually or as a combination of the two methods.

Of particular concern is the wipe dry capability of the wiper in a cleanroom environment. As used here, “wipe dry” is the ability of a wiper to wipe a surface dry of a liquid without leaving a residue. It is related to the ability of the wiper to quickly pick up liquid into the wiper structure during the wiping motion as the wiper is brought across the surface to be wiped. A wiper with a good wipe dry capability will only require one or two passes over the surface, rather than multiple passes, to wipe the surface dry of liquid present. A surface that is wiped dry will no longer have residual evidence (i.e., rivulets or drops) of the liquid.

A wiper with good wipe dry capability will quickly pick up the liquid into the interstices of the structure of the wiper material and hold it there during wiping. The absorbent capacity of a wiper is the maximum amount of fluid that the wiper can contain and is different than the wiper's wipe dry ability. A wiper may have a high absorbent capacity, but not be able to take up the liquid quickly. Such a wiper will often push the liquid around on the surface before the wiper can absorb the liquid. Often materials that are used to increase the absorbency of such a wiper (e.g., cellulosic fibers, superabsorbent particles, etc.) will result in unacceptable levels of lint, particles and residual ions in the critical environments in which such wipers are used.

The ISO classifications of cleanroom environments is based on the particle levels present in the air of such an environment. Cleanrooms that have a lower ISO classification are environments very sensitive to contaminants and consequently have lower limits as to acceptable particle levels. Conversely, the acceptable level of particles present in the air of the cleanroom increases with the ISO classification. For example, cleanroom where semiconductors are manufactured are critical environments where even small amounts of particles could harm the semiconductors. Appropriately, semiconductor manufacturing occurs in ISO class 3 or 4 environments. ISO class 5 and 6 environments, such as used in pharmaceutical and biotech cleanrooms, still require controls as to contaminants, but are less restrictive than ISO class 3 or 4 environments.

Accordingly, wipers designed for use in these environments must be suitable for use in such critical cleanrooms. Wipers to be used in the cleanrooms must not adversely affect the levels of contaminants in the cleanroom. While there is not an existing standard for acceptable particle and ion levels in cleanroom consumables (such as wipers), one can approximate these levels based on the industry averages for the largest manufacturers of such cleanroom consumables. Averages of the particle and ion levels present in commercially available wipers recommended for use in specific ISO cleanroom environments are given in Table 1. The averages in Table 1 are based on commercially available cleanroom wipers from Contec Inc. (Spartanburg, S.C.), Milliken & Company (Spartanburg, S.C.), Berkshire Corporation (Great Barrington, Mass.) and ITW Texwipe (Mahwah, N.J.).

TABLE 1

| | ISO class 3/4 | ISO class 5/6 |
|---|---|---|
| Particles, per m² of | 14 × 10⁶ to 1.25 × 10⁸ | 2 × 10⁸ to 1.2 × 10⁹ |
| wiper, of a size between | | |
| 0.5 and 5.0 microns | | |
| Particles, per m² of | 3 × 10⁵ to 7 × 10⁵ | 1.2 × 10⁶ to 7 × 10⁶ |
| wiper, of a size between | | |
| 5.0 and 100 microns | | |
| Particles, per m² of | 800 to 2900 | 5 × 10⁵ to 8 × 10⁶ |
| wiper, of a size greater | | |
| than 100 microns | | |
| Extractable Ions (ppm) | | |
| Sodium ions | 0 to 0.5 | 0.5 to 50 |
| Potassium ions | 0 to 0.5 | 0.5 to 25 |
| Chloride ions | 0 to 0.3 | 0.3 to 25 |

To meet such stringent lint/particle limits, the substrates used for cleanroom wipers need to be substantially free of any loose fibers. Hence, as known in the art, wiper substrates for critical cleanroom environments (such as ISO class 3) are generally made from continuous filament yarns. Continuous filaments are generally defined as an unbroken strand of synthetic fiber made by extruding molten polymer through a spinnerette. The fibers are cooled and then stretched and textured into bundles referred to as yarn.

Cleanroom wipers have been made from woven cotton, polyurethane foam, polyester-cellulose, and nylon. However, synthetic fibers are more commonly used for more critical cleanroom environments as they generally produce lower levels of lint and extractables than those made with some degree of natural fibers (i.e., cotton, cellulose, etc.). Such synthetic fibers may be polyesters, nylons, polypropylenes, polyethylenes, acrylics, polyvinyls, polyurethanes, and other such synthetic fibers as are well known.

Polyester is the most common material used in cleanroom environments. More particularly, such wipers are typically made from poly(ethylene terephthalate) (“PET”) fibers. The lint levels of wipers made from double knit polyester are much lower than wipers made from other materials such as nonwoven materials, woven cotton, polyester-cellulose blended fibers or the like.

While the use of other continuous, synthetic filaments could be used to make the substrate of the wiper, PET is the material most commonly used within cleanroom environments. For the ease of the remaining discussion of the present invention, the substrate of the wiper of the present invention will be discussed as being made of polyester or PET. However, as discussed above, other synthetic polymers could be used and are not intended to be precluded from use in the present invention.

The knitted wipers of the invention are produced by conventional knitting and processing procedures as are common and known for such cleanroom wipers. First, 100-percent continuous filament polyester yarn is knitted with the desired pattern on a circular knitting machine. Such patterns may include, but are not limited to, an interlock pattern or a pique pattern. The fabric is then slit to the desired width and run through a continuous hot bath where a detergent is added that cleans knitting lubricants off the fabric. This part of the process is referred to as scouring. The temperature and the speed of the scouring process can be adjusted as desired as is well-known in the art. For example, a typical scouring temperature is 110 degrees F. (37.8 degrees C.) and a typical speed through the scouring process is 40 yd/min (36.6 m/min).

The fabric is rinsed in warm water and immediately re-rinsed with a sprinkler system before entering a squeeze roll that removes excess water. The fabric then enters a tenter frame where drying heat is applied. The temperature and the speed of the tender frame drying can be adjusted as desired as is well-known in the art. For example, a typical tenter frame temperature is between 340 and 370 degrees F. (171-188 degrees C.) and the typical speed through the tenter is approximately 35-40 yd/min (36.6-32.0 m/min).

After exiting the tenter frame, the fabric is cut into wipers of the desired size, and the fibers on the wiper edges are fused together using a sealing machine. As known in the art, such sealing may be accomplished by hot wire knife, ultrasonic bonding, laser sealing, thermal bonding and the like.

Once the edges have been sealed, the wipers are laundered in a cleanroom laundry. During the rinse cycle, the chemical treatments can be applied to the fabric. As known in the art, typical rinse temperatures can range between about 130 and 160 degrees F. (54.4-71.1 degrees C.). Typical cycle time is between 40 minutes and one hour. After being rinsed three times in ultrapure (filtered to 0.2 microns) deionized water to remove excess extractables, the wipes enter the cleanroom dryer where they are dried at a temperature of approximately 160 degrees F. (71.1 degrees C.) for 20 to 30 minutes. Once the laundering process is complete, the wipers are doubled bagged in clear PVC anti-static film.

Polyester is naturally hydrophobic which works against the desired wipe dry ability of the wiper to quickly pick up liquids. One method of the invention that overcomes this issue is the use of surface modification treatments.

To improve the wipe dry capability of the wiper it is desired to minimize surface energy difference (or interfacial energy) at the polyester/liquid interface to ensure that liquid wets out the surface of the polyester wiper. For example, PET has a surface energy of about 43 dynes/cm, whereas the surface tension of water is 72 dynes/cm. For a liquid such as water to wet out on the surface of the PET, the gap in surface energy between that of water and the PET substrate must be minimized. (Note that “surface energy” and “surface tension” are used interchangeably; it is customary to use “surface energy” in reference to solids and “surface tension” for liquids.) In the case of the polyester wiper, the surface energy of the wiper needs to be increased closer to the surface tension of the liquid the wiper is wiping up. One would like to increase the surface energy of the polyester wiper to greater than 50 dynes/cm. More desirably, one would prefer to increase the surface energy of the wiper to greater than 60 dynes/cm. Even more desirably, one would prefer to increase the surface energy of the wiper to greater than 70 dynes/cm and ideally the surface energy would be 80 dynes/cm or greater.

Another related characteristic that can be used to determine the wettability of a substrate is contact angle, the angle formed by the solid/liquid interface and the liquid/vapor interface measured from the side of the liquid. The contact angle is highly dependent upon the surface energy of the solid and liquid under consideration. If the surface energy of the liquid is significantly higher than that of the solid, as in the case of water and polyester, the cohesive bonds in the liquid will be stronger than the attraction between the liquid and solid. This will cause the liquid to bead up on the solid, creating a large contact angle. Liquids will only wet surfaces when the contact angle is less than 90 degrees. As a smaller difference in surface energy between a liquid and solid gives a smaller contact angle, one can improve the wettability of a solid by altering the solid or liquid such that the difference in surface energy is minimized.

While a contact angle of less than 90 degrees is required for the a liquid to wet the surface of the wiper, it is desired that the contact angle be even lower for better wettability of such a wiper. It is preferable that the contact angle be less than 80 degrees. It is more desirable for the contact angle to be less than 70 degrees. A contact angle less than 60 degrees would be even more desirable. A contact angle less than 40 degrees would be even more desirable.

Conventional surfactants have been used for many years to treat nonwoven fabrics to promote wettability of such fabrics for use in absorbent products such as diapers, feminine care products, and the like. Surfactants typically have a polar head and a hydrophobic (non-polar) tail that, when placed on the hydrophobic surface of the fabric, orient themselves to provide a fabric surface that is wettable to aqueous fluids.

Such surfactants are typically derivatives of natural substances such as fatty acids that typically have chains that are no longer than 22 carbons in length. Synthetic analogs of fatty acid derivatives are also available. Generally, such surfactants require that relatively high concentrations of surfactant be used to achieve the desired levels of wetting and absorbency of liquids. Typically, due to their segregated and dual polar and non-polar characters, conventional surfactants will tend to reach a critical concentration (i.e. critical micelle concentration or CMC) at which aggregation of surfactant molecules occur in the form of spherical micelles where the tails (or hydrophobic portions) converge on themselves away from the aqueous phase. It is well understood that when relatively high CMC is reached for a typical surfactant, its physical properties (e.g. surface activity or ability to induce surface tension reduction) level off. It is also well understood that surface activity is highly dependent on surfactant concentration. In the case of clean room wipers, due to concerns about particles, ions and residue, it is desirable to use the lowest amount of surfactant to achieve the minimum, preferably zero, interfacial energy at the PET wiper/liquid interface.

Conventional, or simple, surfactants generally consist of a single hydrophilic head and one or two hydrophobic tails. Examples of such conventional surfactants include Synthrapol KB, Tween 85, Aerosol OT, and a broad range of ethoxylated fatty esters and alcohols, which are readily available from various vendors such as Uniqema (New Castle, Del.), Cognis Corp. (Cincinnati, Ohio), and BASF (Florham Park, N.J.). Other classes of conventional surfactants include ethoxylated polydimethyl siloxanes (available from Dow Corning, GE, and others) and ethoxylated fluorocarbons (available from 3M, DuPont, and others).

The surface treatments of the present invention provide benefits to cleanroom wiper applications that conventional surfactants are unable to provide. One such class of synthetic surfactants is known as gemini surfactants (also referred to as dimeric surfactants). Unlike the simple structure of conventional surfactants, gemini surfactants are characterized by multiple hydrophilic head groups and multiple hydrophobic tails connected by a linkage, commonly called a spacer, located near the hydrophilic head groups. A typical gemini surfactant consists of two conventional simple surfactants that are covalently joined by a spacer. The hydrophilic head groups may be identical or different from each other and the hydrophobic tails may be identical or different from each other. Gemini surfactants may be symmetrical or nonsymmetrical. The spacer can be hydrophobic (e.g., aliphatic or aromatic) or hydrophilic (e.g., polyether), short (e.g., 1 to 2 methylene groups) or long (e.g., 3 to 12 methylene groups), rigid or flexible.

Unique characteristics of gemini surfactants include their ability to reduce surface tension of liquids at much reduced concentration relative to conventional surfactants. Another distinguishing feature of gemini surfactants is their aggregation behavior in solution. Gemini surfactants have tendency to aggregate in less-ordered spherical micelles than normally found with conventional surfactants. As a result, gemini surfactants are significantly more surface active and are significantly more efficient (i.e. effective at much lower concentrations than conventional surfactants). Results of study on gemini surfactants can be found in the following reference: “A theoretical Study of Gemini Surfactant Phase Behavior”, K. M. Layn et al., Journal of Chemical Physics, vol 109, Number 13, pp. 5651-5658, 1 Oct. 1998.

Examples of such commercially available gemini surfactants include Dynol 604 (2,5,8,11 tetramethyl 6 dodecyn-5, diol ethoxylate); Surfynol 440 (Ethoxylated 2,4,7,9-tetramethyl 5 decyn 4,7-diol (ethylene oxide-40% by weight)); Surfynol 485 (Ethoxylated 2,4,7,9-tetramethyl 5 decyn 4,7-diol (ethylene oxide-85% by weight)); and Surfynol 420 (65% by weight Ethoxylated 2,4,7,9-tetramethyl 5 decyn-4,7-diol, 25% by weight Tetramethyl-5-decyne-4,7-diol, 2,4,7,9). All such surfactants are available from Air Products Polymers L.P. of Dalton, Ga.

Another class of synthetic surfactants is functionalized oligomers. Functionalized oligomers are synthetic low molecular weight polyolefins (e.g., polyethylene, polypropylene, or their copolymers) which are functionalized with polar functional groups such as polyethylene oxide or other groups such as carboxylic acid, sulfate, sulfonate, hydroxyl, amine, amide, anhydride, etc. These oligomers generally exhibit hydrophobic or polyolefin tails that contain more than 22 carbons. Generally strong adsorption onto PET occurs due to both apolar forces (long alkyl chain) as well as polar forces between the polar ester groups on PET and the polar groups on the functionalized oligomer. Generally, these functionalized oligomers, especially the ethoxylated oligomers, exhibit low levels of ions because the “ethoxylate” group is non-ionic and is charge neutral. Examples of such commercially available substances includes Unithox 490 (alcohols ethoxylated, ethane homopolymer (ethylene oxide—90% by weight)) from Baker Petrolite of Sugar Land, Tex.

Finally, a third class of such synthetic surfactants is polymer wetting agents. Polymeric wetting agents are water soluble synthetic polymers such as polyvinyl pyrolidone, polyacrylic acid (PAA), polyacrylamide (PAM), polyacryamido-methyl-propane sulfonic acid (PAMPS), water soluble cellulose (or polysaccharides) derivatives such as ethyl hydroxylethyl cellulose (EHEC), carboxy methyl cellulose (CMC) and many other water soluble polysaccharides. Other proprietary water soluble polymers are made by Rhodia, Inc. of Cranbury, N.J., include Hydrosystem 105-2, Hydropol and Repel-o-tex QCX-2 (15% Polyethylene glycol polyester dispersion, 85% water, <0.0006% dioxane, <0.0005% ethylene oxide).

Besides using a chemical additive such as a surfactant, other surface treatments can be used to modify the surface energy of the wiper. For example, glow discharge (GD) treatments by atmospheric plasma or corona. GD treatments can enhance surface energy of PET to higher than 50 dynes/cm, thereby making it more wettable to aqueous fluids. GD by atmospheric plasma is preferred because it allows for surface oxidation (or other polar groups) that is more durable overtime. Also, flame treatment is another process that can achieve similar results to GD treatment.

Another potential surface treatment is radiation-induced graft-copolymerization of hydrophilic monomers onto PET. Typical hydrophilic monomers (or water soluble monomers) include but are not limited to are N-vinyl pyrrolidone (NVP), acrylic acid, hydroxyethyl methacrylate (HEMA), etc., which can be graft-coplymerized onto PET via gamma radiation, electron-beam, UV radiation, or the like. Also, it is possible to combine a GD (atmospheric plasma or Corona) treatment to pre-oxidize PET followed by the radiation-induced graft-copolymerization process. The pre-oxidation step can raise the surface energy of PET so that a more favorable wetting of the PET by the graft-copolymerization's aqueous monomer can occur. Thus, a better grafting efficiency and grafting uniformity may occur.

Surfactants are generally applied to the wipers during the rinse cycle of the laundering process of the production of the knitted polyester wipers. The laundering process is the most convenient place to add the surfactants to the wipers as all of the processing chemicals used in the melt-extrusion of the PET fibers and the manufacture of such wipers have been washed off and will not interfere with the addition of the desired surfactant. Surfactant is added to the rinse batch at a weight percentage of approximately 0.06 to 0.5% by weight of the wipers being rinsed (i.e., 1 to 8 ounces (28 to 227 grams) of surfactant for every 100 lbs (45.4 kg) of wipers). The wipers are washed with ultra pure deionized water filtered to 0.2 micron in a 200 gallon (757 L) capacity washer. The typical batch size of wipers laundered at one time is 100 lbs. (45.4 kg) of wipers.

However, other methods can be used in the wiper production processing to impart surface treatments discussed above. For example, one may treat PET fibers or PET yarn following melt extrusion and prior to spooling using any suitable wet chemistry process (surfactant, water soluble polymers, and the like). Similarly, the surface treatment may be incorporated into the fiber during the melt-extrusion of the fibers. Alternatively, one may treat the knitted PET in a roll form using conventional wet chemistry with saturation, spray, gravure, foam, slot die, or similar processes followed by drying. In another treatment method, one may treat the knitted PET in a roll form using conventional wet chemistry with saturation, spray, gravure, foam, slot die, or similar processes followed by irradiation by gamma, e-beam or UV, followed by drying. Finally, one may treat the knitted PET in a roll form using a GD or flame treatment.

In addition to each of these surface treatments being used individually, combinations of such treatments could be used together. By way of non-limiting example, combinations of the surfactant classes could be used together. In another non-limiting example, combinations of a surfactant along with plasma treatment may increase the wipe dry ability of the knitted polyester wiper. One skilled in the art, in view of discussion above, would be able to see that there are numerous combinations of such surface treatments that could be used individually, or in combination, to improve the wipe dry ability of the knitted polyester wiper.

Alternatively, or in addition to, treating the surface of the knitted polyester fabric, the structure of the fabric can be modified to improve the wipe dry ability of the wiper. While the inventors do not wish to be held to or be limited by a particular theory of operation, it is believed that the ability of the knitted polyester wiper to absorb and retain water is a function of the capillary structure of the fabric. The capillary force driving the water into the pores of the fabric is a function of the surface tension of the liquid-gas interface, the contact angle and the size of the pore itself. As is well known, the “pores” of a woven fabric are the discrete void volumes within the fabric as defined by the filaments that make up the yarn (intra-yarn voids/pores) and as defined by the yarns that make up the woven fabric (inter-yarn voids/pores).

The contact angle is the angle formed by the solid/liquid interface and the liquid/gas interface measured from the side of the liquid. The smaller the contact angle, the more effectively the liquid will wet-out the surface. The contact angle is a function of the surface tension of the liquid and the surface energy of the receiving surface, and can be altered through chemical treatment of the receiving surface, as described above.

The driving force for capillary action can be expressed by the following formula:
Force=2Πrσ_{LG} cos θ

Where:

r=Radius of pore opening

σ_{LG}=Liquid-gas surface tension

θ=Contact angle

As pressure is the force over a given area, the pressure developed, called the capillary pressure, can be written as:
Capillary Pressure=(2σ_{LG} cos θ)/r

The larger the capillary pressure, the stronger the force driving liquid into the pores of the fabric. Therefore, in order to maximize the amount of fluid absorbed into the fabric, one must maximize the capillary pressure. This can be done by minimizing the contact angle and/or by minimizing the radius of the pore opening.

The desire in optimizing capillary structure of fabric by optimizing the pore size distribution is to maximize the percentage of pores in the 50 micron and less size range. These smaller pores are a function of the yarn structure (filaments/yarn, filament structure (grooved vs. not grooved), yarn denier, and yarn geometry (round vs. notched cross section)). To maximize wipe dry, 20 to 75 percent of the pores of the knitted fabric should be of a size of 50 micron or less. It has been found that wipe dry performance can be enhanced by fabrics having 5 to 25 percent of the pores of a size of 20 microns or less.

In theory, 100 percent of the pores being 50 micron or less would result in a fabric with maximum wipe dry. However, having too many pores in this size range can lead to a fabric that is essentially impervious to liquid. A percentage (15 to 80 percent) of the pores should be in the size range of 60 to 160 microns for the fabric to be able to hold any significant amount of fluid. Pores in this size range are a function of the inter-yarn structure, which is determined by the knit style (double vs. single knit) and knit pattern (i.e. interlock vs. pique). In general, single knits have smaller inter-yarn pores than double knits, and pique patterns have smaller inter-yarn pores than interlock patterns. However, single knits tend to generate more lint due to their structure which makes them less suitable for use in a cleanroom environment. Double knits are less linty than pique knits, but both are suitable for use in the cleanroom. Adjusting knit style and pattern so as to keep a portion of inter-yarn pores in the 60 to 160 micron range will maximize the fabric's fluid handling capabilities (and thus wipe dry). It has been found that wipe dry is improved with a wiper having 30 to 50 percent of the pores within the size range of 60 to 160 microns.

Alteration of the knit structure involves changing the way in which yarns are knitted together so as to optimize the size and number of voids available for receiving fluid. In knitting, a course refers to horizontal rows of loops and a wale to vertical columns of loops. Decreasing the number of courses and wales loosens the stitch, increasing the size of the voids available for receiving fluid. The tightness of the stitch can be optimized to improve the fabric's ability to wick and retain fluid, leaving a surface dry after wiping. Decreasing the number of courses and wales below 30 will lead to pores that are too large, resulting in a fabric that is unable to retain fluid. The desired range of number of wales is 30 to 45 and the desired range fro the number of courses is 35 to 65.

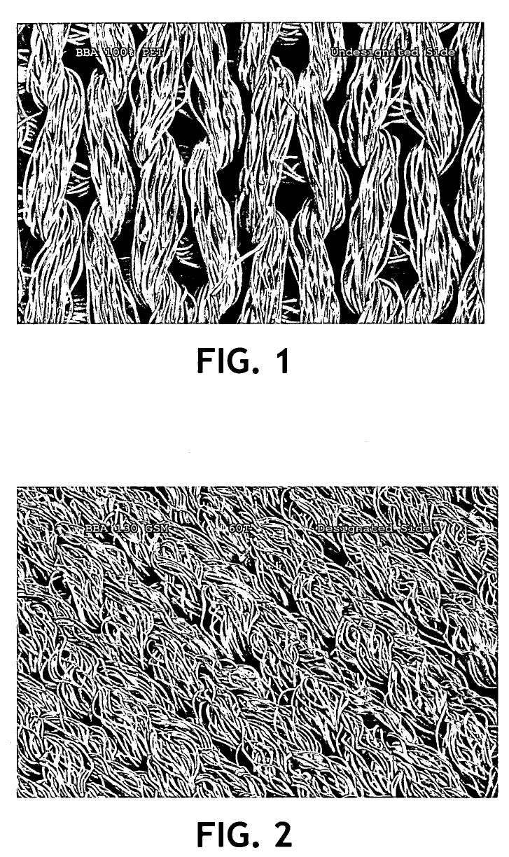

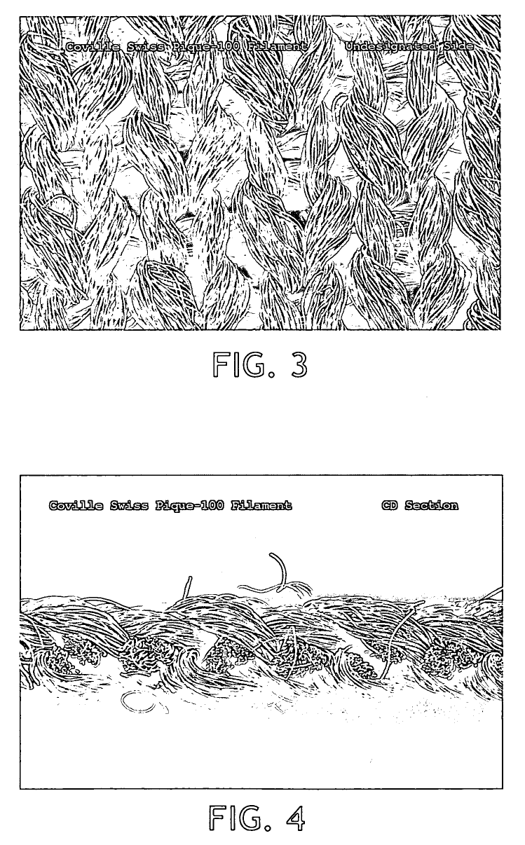

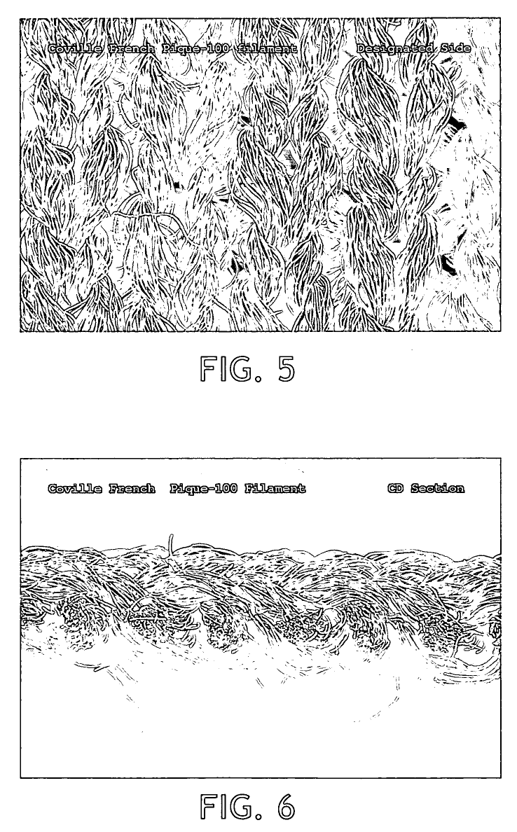

Another method of altering the fabric structure involves changing the knit pattern. A majority of cleanroom wipers are made with an interlocking knit pattern having repeating loops over and under (see FIG. 1 [50× magnification] and FIG. 2 [40× magnification]). Alternative knit patterns can be used to reduce the size of the pore openings while maximizing the number of available pores. An example of such a knit pattern includes pique patterns such as the Swiss pique (See FIGS. 3 and 4, both at 50× magnification) and French pique (See FIGS. 5 and 6, both at 50× magnification) patterns available from Coville, Inc. The pique patterns are a tighter knit than the interlocking knit pattern.

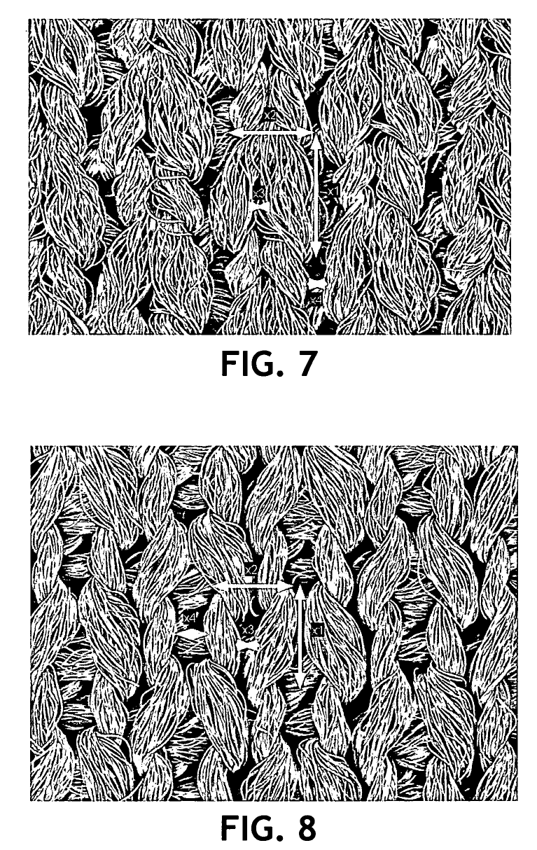

FIGS. 7 and 8 are scanning electron micrographs, at 50× magnification, which illustrate a comparison of a loose stitch (FIG. 7) and a tight stitch (FIG. 8), using the same knitting pattern (Coville French pique) and same filament count. As shown in FIGS. 7 and 8, ×1 is the length of the stitch, ×2 is the width of the stitch, ×3 is the distance between yarns and ×4 is the distance between wales. An analysis of these variables for the fabrics depicted in FIGS. 7 and 8 shows that the length of a loose stitch (FIG. 7) is approximately 10 percent greater than that of a tight stitch (FIG. 8) and the width is approximately 9 percent greater for loose versus tight. The distance between yarns for a tight stitch is approximately 275 percent greater than for a loose stitch, and the distance between wales is approximately 60 percent less for loose versus tight.

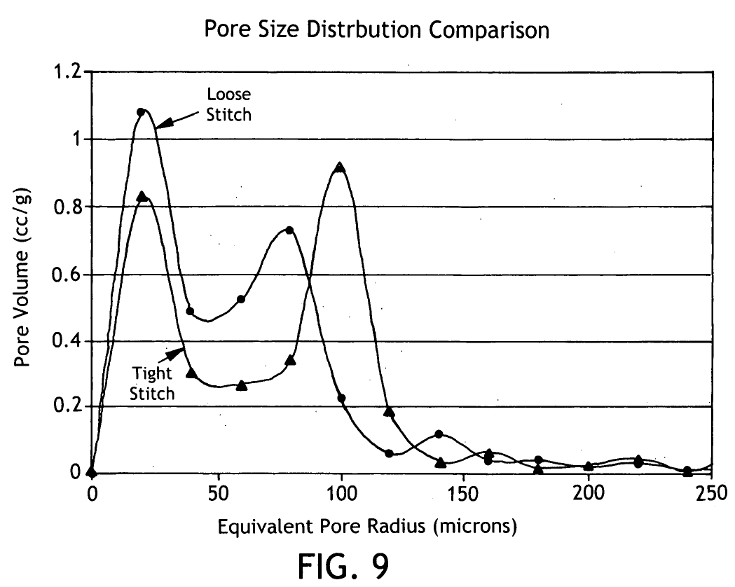

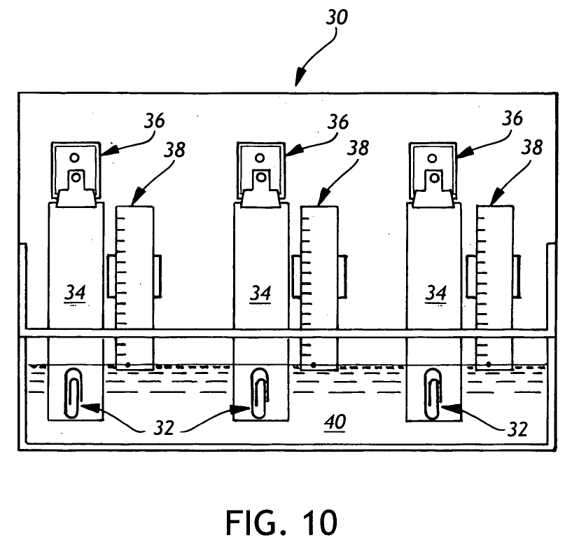

As can be seen from the figures, the loosening the knit pattern reduces the distance between yarns. This leads to a larger percentage of pores in the 0 to 20 micron range and thus improves wipe dry performance. A comparison of the pore size distributions for the loose stitch fabric of FIG. 7 and the tight stitch pique fabric of FIG. 8 is shown in FIG. 9. As shown in FIG. 9, the loose stitch fabric has a larger volume of pores in the 0 to 20 micron range.

An additional method of improving the wipe dry of the wiper by altering the fabric structure is by increasing the filament count. A filament refers to the individual fibers that make up a single strand of yarn. See FIGS. 4 and 6. Increasing the number of filaments in a yarn decreases the size of the pores within the yarn, improving the capillary action of the yarn. Typical polyester knitted cleanroom wipers have filament counts in the range of 34 to 60. Increasing filament count above 60 gives an improvement in wipe dry. The range of filament counts for optimizing wipe dry is 60 to 120. Fabrics with such a filament count range are considered to be micro-fiber fabrics.

Another method of improving capillary structure through yarn alteration is varying the denier of the yarn. Decreasing the yarn denier while keeping filament count constant results in smaller diameter filaments. This has the same effect on wipe dry as increasing the filament count per yarn; it decreases the size of the pores within the yarn.

Finally, the ability of a fabric to wick and retain fluid can be enhanced by altering the structure of the yarn itself. A majority of knits used in the cleanroom are made with yarns that have a cylindrical cross section. Creating notches in the yarn can increase the number of voids available for receiving fluid. These notches can be achieved in two ways: yarn may be purchased with a notched cross or by mechanically treating the surface of the fabric to “bend” the yarns, creating notches in the cross section.

The second option can be achieved by creping the fabric using a doctor blade. As noted above, this creates notches in the yarn that increase the area available for holding fluid. Creping of nonwoven fabrics and wet-laid cellulosic webs is well known in the art and can be similarly applied to the knitted fabrics of the present invention. Examples of the creping of fabrics may be found in U.S. Pat. Nos. 4,810,556; 6,150,002; 6,673,980; and 6,835,264. Creping the fabric with a doctor blade essentially bends the yarn, creating grooves that increase the number of voids available for receiving fluid. The fabric is run under a doctor blade that mechanically compresses the fabric, impressing grooves in the yarn. These grooves increase the amount of space available for receiving and retaining fluid. Varying the doctor blade design can alter the amount of compaction the fabric experiences. For this application, doctor blades that deliver compaction in the range of 10 to 20 percent are sufficient to give an improvement in wipe dry.

In addition to each of these fabric structure modifications being used individually, combinations of such modifications could be used together. By way of non-limiting example, a knitted polyester wiper could be made with a French pique pattern, a filament count of 80, and 60 courses with 40 wales. Another example could be a wiper made with an interlock pattern, and a filament count of 120, where the wiper is creped. One skilled in the art, in view of discussion above, would be able to see that there are numerous combinations of such fabric structure modifications that could be used individually, or in combination, to improve the wipe dry ability of the knitted polyester wiper.

Finally, the surface treatment methods and fabric structure modifications could be used in combination to improve the wipe dry ability of the knitted polyester wiper. By way of non-limiting example, a knitted polyester wiper could be made with a French pique pattern, a filament count of 80, having 60 courses with 40 wales, and treated with a gemini surfactant such as Surfynol 440. Another example could be a wiper made with an interlock pattern, a filament count of 120, where the wiper is creped and surface treated by atmospheric plasma. One skilled in the art, in view of discussion above, would be able to see that there are numerous combinations of such fabric structure modifications and surface treatments that could be used individually, or in combination, to improve the wipe dry ability of the knitted polyester wiper.

### Testing

Vertical Wicking Test: The vertical wicking test measures the height of water that can be vertically wicked by the sample in a given period of time. A reservoir or containing purified distilled/deionized water is provided. One end of a 25 mm×203 mm (1 inch×8 inch) specimen is clamped and the other end is placed in the fluid such that it extends 2.5 cm therein. An apparatus 30 can be used similar to that depicted in FIG. 7. A paper clip 32 or other weight may be used to weigh the lower end of the specimen 34 and prevent the specimen from curling and allow the lower end of the specimen to readily submerge into the water 40 in the reservoir. Support blocks 36 maintain the specimen at a fixed height. The degree of liquid migration in centimeters is measured at 15 second, 30 second, 45 second and 60 second intervals. A ruler 38 or other device can be used to determine the degree of liquid migration up the specimen. Tests are conducted in a laboratory atmosphere of 23+/−1 degrees C. and 50+/−5% RH. The vertical wicking value for a sample is given as the average of at least three specimens. The vertical wicking test may be performed on specimens taken along the machine direction (MD) or the cross direction (CD) of the sample.

Absorbent Capacity Test: As used herein, “absorbent capacity” refers to the amount of liquid that an initially 4-inch by 4-inch (102 mm×102 mm) sample of material can absorb while in contact with a pool 2 inches (51 mm) deep of room-temperature (23+/−2 degrees C.) liquid for 3 minutes+/−5 seconds in a standard laboratory atmosphere of 23+/−1 degrees C. and 50+/−2% RH and still retain after being removed from contact with liquid and being clamped by a one-point clamp to drain for 3 minutes+/−5 seconds. Absorbent capacity is expressed as both an absolute capacity in grams of liquid and as a specific capacity of grams of liquid held per gram of dry fiber, as measured to the nearest 0.01 gram. At least three specimens are tested for each sample. Samples may be tested for their absorbent capacity in water and their absorbent capacity in isopropyl alcohol (IPA).

Water Absorbency Rate: As used herein, the “Water Absorbency Rate” is a measure of the rate at which a sample material will absorb water by measuring the time required for it to be wet on 100 percent of its surface by distilled water. To measure the Water Absorbency Rate, 9-inch by 9-inch (229 mm×229 mm) dry specimens are used. At least three specimens are tested for each sample. Testing is conducted in a standard laboratory atmosphere of 23+/−1 degrees C. and 50+/−2 percent RH. A pan having an inner diameter larger than each specimen and having a depth of greater than 2 inches (51 mm) is provided. The pan is filled with distilled water to a depth of at least 2 inches (51 mm). The water is allowed to stand for thirty (30) minutes to allow the water to equilibrate to the room temperature (23+/−1 degrees C.). A timer accurate and readable to 0.1 sec. is started when the first specimen contacts the water. The timer is stopped when the surface of the specimens is completely, i.e., 100 percent, wet. Results are recorded in seconds, to the nearest 0.1 sec. The absorbency rate is the average of the three (3) absorbency readings.

Water Intake Rate: The intake rate of water is the time required, in seconds, for a sample to completely absorb the liquid in the web versus sitting on the material surface. Specifically, the intake of water is determined according to ASTM No. 2410 by delivering 0.1 cubic centimeters of water with a pipette to the material surface. Four (4) 0.1-cubic centimeter drops of water (2 drops per side) are applied to each material surface. The average time, in seconds, for the four drops of water to wick into the material (z-direction) is recorded. Lower absorption times are indicative of a faster intake rate. The test is run at conditions of 23+/−1 degrees C. and 50%+/−5% RH.

Gelbo Lint Test: The amount of lint for a given sample was determined according to the Gelbo Lint Test. The Gelbo Lint Test determines the relative number of particles released from a fabric when it is subjected to a continuous flexing and twisting movement. It is performed in accordance with INDA test method 160.1-92. A sample is placed in a flexing chamber. As the sample is flexed, air is withdrawn from the chamber at 1 cubic foot per minute (0.028 m³/min) for counting in a laser particle counter. The particle counter counts the particles by size for less than or greater than a certain particle size (e.g., 25 microns) using channels to size the particles. The results may be reported as the total particles counted over ten consecutive 30-second periods, the maximum concentration achieved in one of the ten counting periods or as an average of the ten counting periods. The test indicates the lint generating potential of a material.

Readily Releasable Particles by Biaxial Shake Test: The biaxial shake test measures the number of particles in the size range of 0.5 microns and 20 microns after shaking the specimen in water. Results are reported for particular size ranges as the number of particles per square meter of specimen. The biaxial shake test was conducted using test method IEST RP-CC004.3, Section 6.1.3.

Taber Abrasion Resistance Test: Taber Abrasion resistance measures the abrasion resistance in terms of destruction of the fabric produced by a controlled, rotary rubbing action. Abrasion resistance is measured in accordance with Method 5306, Federal Test Methods Standard No. 191A, except as otherwise noted herein. Only a single wheel is used to abrade the specimen. A 5-inch by 5-inch (127 mm×127 mm) specimen is clamped to the specimen platform of a Taber Standard Abrader (Model No. 504 with Model No. E-140-15 specimen holder) having a rubber wheel (No. H-18) on the abrading head and a 500-gram counterweight on each arm. The loss in breaking strength is not used as the criteria for determining abrasion resistance. The results are obtained and reported in abrasion cycles to failure where failure was deemed to occur at that point where a 0.5-inch (13 mm) hole is produced within the fabric.

Grab Tensile Test: The grab tensile test is a measure of breaking strength of a fabric when subjected to unidirectional stress. This test is known in the art and conforms to the specification of Method 5100 of the Federal Test Methods Standard 191A. The results are expressed in pounds to break. Higher numbers indicate a stronger fabric. The grab tensile test used two clamps, each having two jaws with each jaw having a facing in contact with the sample. The clamps hold the material in the same plane, usually vertically, separated by 3 inches (76 mm) and move apart at a specified rate of extension. Values for grab tensile strength are obtained using a sample size of 4 inches (102 mm) by 6 inches (152 mm), with a jaw facing size of 1 inch (25 mm) by 1 inch (25 mm), and at a constant rate of extension of 300 mm/min. The sample is wider than the clamp jaws to give results representative of effective strength of fibers in the clamped width combined with additional strength contributed by adjacent fibers in the fabric. The specimen is clamped in, for example, a Sintech 2 tester, available form the Sintech Corporation of Cary, N.C., and Instron Model™, available from Instron Corporation of Canton, Mass., or a Thwing-Albert Model INTELLECT II available from the Thwing-Albert Instrument Co. of Philadelphia, Pa. This closely simulates fabric stress conditions in actual use. Results are reported as the average of three specimens and may be performed with the specimen in the cross direction (CD) or the machine direction (MD).

Extractable Ion test The extractable ion test measures specific levels of K, Na, Cl, Ca, nitrate, phosphate and sulfate ions present in the sample. The level of each ion present is reported as milligrams per gram of sample. The extractable ion levels were determined using test method IEST RP—CC004.3, Section 7.2.2.

Nonvolatile Residue Test: The nonvolatile residue test measures that leachables present on the sample. Results are reported in microgram per gram of sample and as milligram per square meter of sample. The nonvolatile residue test was conducted using test method IEST RP—CC004.3, Section 7.1.2.

Dynamic Wiping Efficiency: The dynamic wiping efficiency measures the ability of a fabric to remove liquids from a surface, usually for spill removal. The results are reported as the percentage of test liquid sorbed by the sample fabric after being wiped over the test liquid. The test was conducted using ASTM D6650-01, Section 10.2.

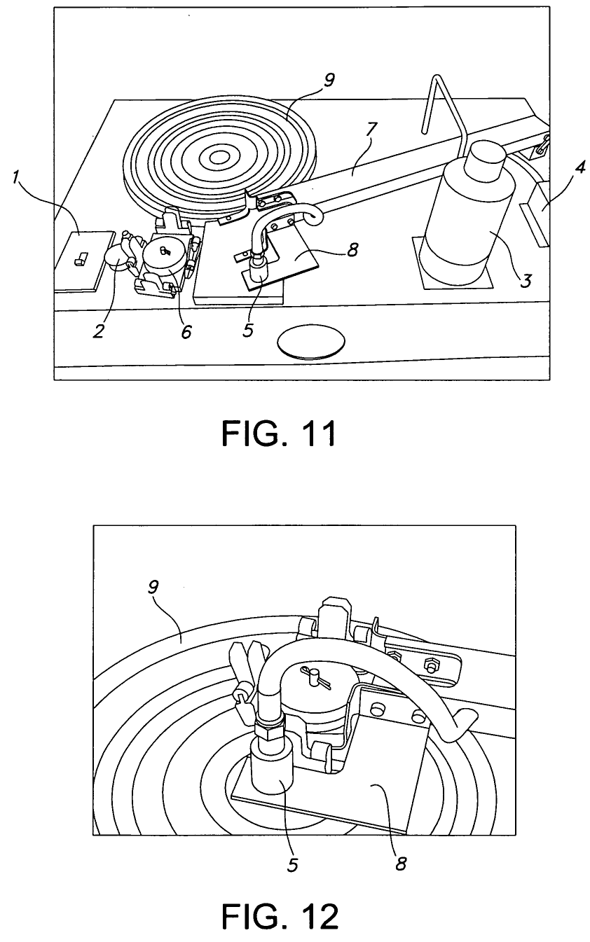

Wipe Dry Test (Version 1.0): The wipe dry test measures the dry area on a surface left dry after liquid is wiped from the surface by a specimen wiper. Results are reported in square centimeters. The equipment used to measure the wipe dry capability of the wiper is shown in FIGS. 11 and 12. The device used to measure the wipe dry capability of wipers for liquid spills is preformed with the equipment and method substantially similar as disclosed in U.S. Pat. No. 4,096,311, which is hereby incorporated by reference. The wipe dry testing includes the following steps:
1. A sample of wiper being tested is mounted on a padded surface of a sample sled 8 (10 cm×6.3 cm);
2. The sample sled 8 is mounted on an traverse arm 7 designed to traverse the sample sled 8 across a rotating disk 9;
3. The sample sled 8 is weighted so that the combined weight of the sample sled 8 and sample is about 770 grams;
4. The sample sled 8 and traverse arm 7 are positioned on a horizontal rotatable disc 9 with the sample being pressed against the surface of the disc 9 by the weighted sample sled 8 (the sled and traverse arm being positioned with the leading edge of the sled 8 (6.3 cm side) just off the center of the disc 9 and with the 10 cm centerline of the sled 8 being positioned along a radial line of the disc so that the trailing 6.3 cm edge is positioned near the perimeter of the disc 9);
5. 0.5 ml of test solution is dispensed on the center of the disc 9 in front of the leading edge of the sled 8 (sufficient surfactant is added to the water so that it leaves a film when wiped rather than discrete droplets. The test solution is delivered from a fluid reservoir 3 by a fluid metering pump 4 and on to the disk through the fluid nozzle 5, once the fluid dispensing button 2 has been depressed. For this test, a 0.0125% Tergitol 15-S-15 solution was used;
6. The disc 9 having a diameter of about 60 cm is rotated at about 65 rpm while the traverse arm 7 moves the sled 8 across the disc at a speed of about 1.27 cm per table revolution (as set with the traverse arm speed selector 6) until the trailing edge of the sled 8 crosses off the outer edge of the disc 9, at which point the test is stopped. From start to finish of the test takes approximately 20 seconds;
7. The wiping effect of the test sample upon the test solution is observed during the test as the sled 8 wipes across the disc 9, in particular the wetted surface is observed and a wiped dry area appears at the center of the disc 9 and enlarges radially on the disc 9;
8. At the moment the test is stopped (when the trailing edge of the sled 8 passes off the edge of the disc 9) the size of the wiped dry area in square centimeters at the center of the disc 9 is observed (if any) and recorded. To aid in the observation of the size of the area on the disc 9 wiped dry by the test sample, concentric circular score lines are made on the surface of the disc 9 corresponding to 50, 100, 200, 300, 400, 500, and 750 cm² circles so that the size of the dry area can be quickly determined by visually comparing the dry area to a reference score line of known area.

The test is performed under constant temperature and relative humidity conditions (23+/−1 degrees C., 50% RH+/−2%). The test is performed ten times for each sample (5 times each with the outside and inside towel surfaces against the rotating surface). The turntable is cleaned with a wiper and distilled water, twice, before testing another sample. The average of 5 measurements for each surface is determined and reported as the wipe dry index in square centimeters for that surface of the sample being tested. Higher turntable speeds may be used as a tool for differentiating between samples reading 1000 at 0.5″. Material samples may be tested in the machine direction (MD) and in the cross direction (CD) of the samples.

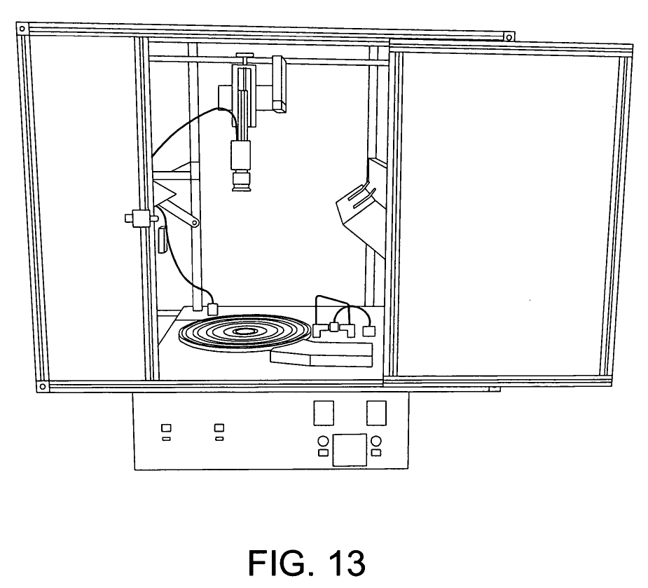

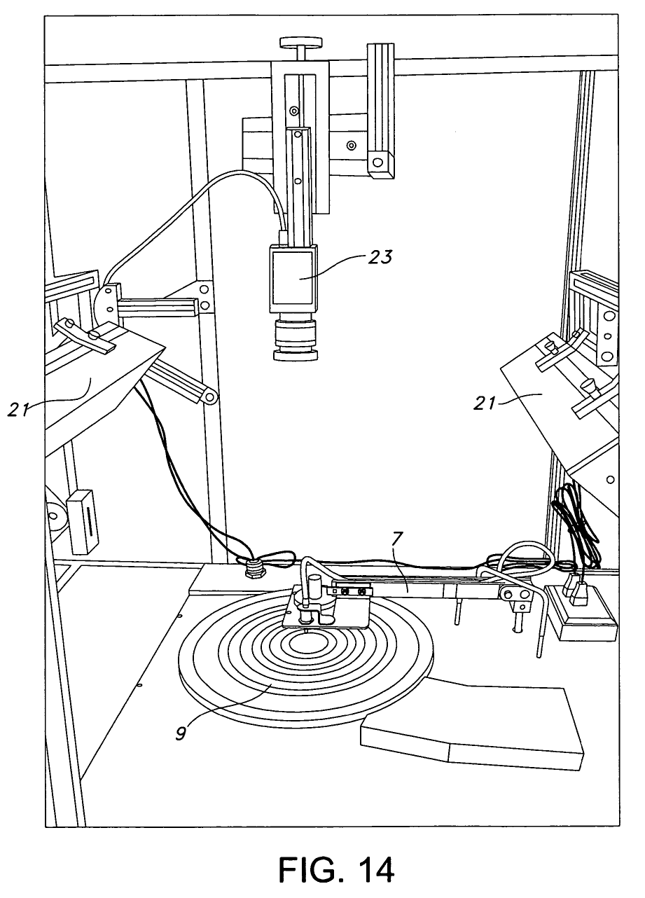

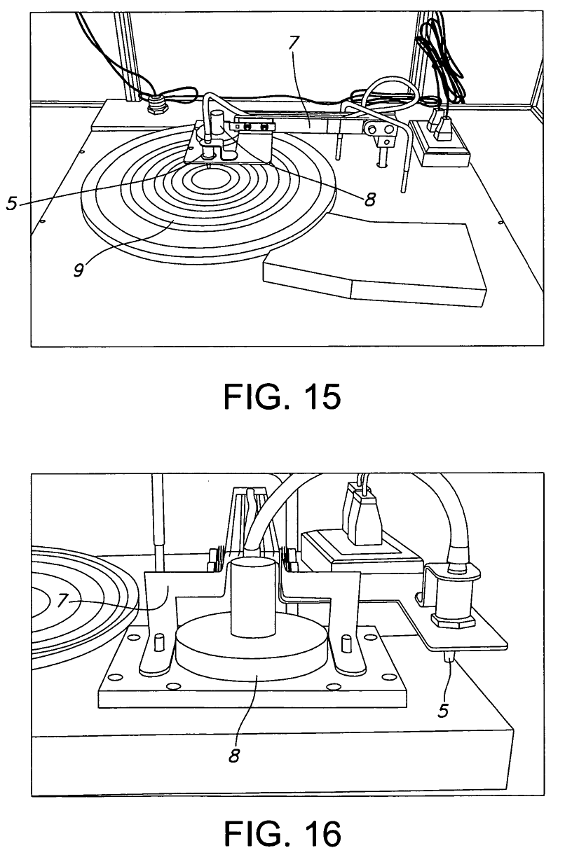

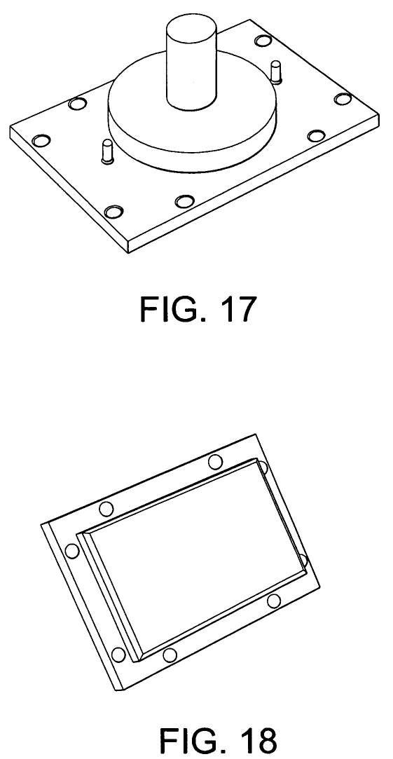

Wipe Dry Test (Version 2.0): An improved wipe dry testing apparatus has been developed and is shown in FIGS. 13-18. The equipment is functionally identical to the previously used wipe dry testing apparatus with the addition of image capturing technology. The new apparatus uses ultra violet light, provided by ultraviolet lamps 21, to illuminate test fluid on the disc surface 9 and a camera 23 to capture an image of the test fluid remaining on the disc 9 when the test is stopped. A computer loaded with related imaging software then computes the area of fluid remaining on the disc 9 and reports the dry area of the disc 9. As such, the improved test method provides more accurate determination of the amount of fluid remaining on the disc surface 9 and provides better reproducibility of results.

The improved wipe dry test is conducted in the same manner as described above for the Wipe Dry Test (Version 1.0) except for the following changes:
1) The improved test uses 4 mL of a 75 ppm Fluorescein sodium salt solution as the test fluid. The solution is made by adding 0.285 g Fluorescein sodium salt (from Sigma-Aldrich, Cat Number: F6377-100 g) and 0.22 g of Tergitol 15-S-9 to 3780 mL of distilled water.
2) The wiper is quarter-folded and oriented in the sample holder 8 such that the folded edge is the first to come in contact with the liquid. The quarter-folding better replicates typical usage of the wiper in cleanroom environments. For a typical test, five repetitions are performed on each side of the fabric. The final wipe dry number is the average of these 10 repetitions.

Pore Size Distribution Test: A pore radius distribution chart shows pore radius in microns along the x-axis and pore volume (volume absorbed in cc of liquid/gram of dry sample at that pore interval) along the y-axis. The peak pore size (rpeak) was extracted from this chart by measuring the value of pore radius at the largest value of volume absorbed from the distribution of pore volume (cc/g) vs. pore radius. This distribution is determined by using an apparatus based on the porous plate method reported by Burgeni and Kapur in the Textile Research Journal Volume 37, 356-366 (1967). The system is a modified version of the porous plate method and consists of a movable Velmex stage interfaced with a programmable stepper motor and an electronic balance controlled by a computer. A control program automatically moves the stage to the desired height, collects data at a specified sampling rate until equilibrium is reached, and then moves to the next calculated height. Controllable parameters of the method include sampling rates, criteria for equilibrium and the number of absorption/desorption cycles.

Data for this analysis was collected using mineral oil (Peneteck Technical Mineral Oil) with a viscosity of 6 centipoise manufactured by Penreco of Los Angeles, Calif. in desorption mode. That is, the material was saturated at zero height and the porous plate (and the effective capillary tension on the sample) was progressively raised in discrete steps corresponding to the desired capillary radius. The amount of liquid pulled out from the sample was monitored. Readings at each height were taken every fifteen seconds and equilibrium was assumed to be reached when the average change of four consecutive readings was less than 0.005 g. This method is described in more detail in U.S. Pat. No. 5,679,042 to Varona.

### EXAMPLES

### Examples 1-4

Knitted polyester wipers were used as the base material for Examples 1 through 4. The wipers were 100 percent continuous filament double-knit polyester provided by Quality Textile Company, Mill Spring, N.C. (“QTC”). The fabric was a 135 gsm interlock stitch of 70 denier/34 filament yarn and having 36 courses and 36 wales. (This material was used throughout sample testing and is referred to herein as the “QTC Control wiper.”)

The QTC Control wipers were saturated in various baths containing various wetting agents as detailed in Table 2. The Surfynol 440, Surfynol 485, and Dynol 604 were obtained from Air Products Polymers LP, Dalton, Ga. The Unithox 490 was obtained from Baker Petrolite, Sugar Land, Tex.

After being saturated, the wipers were nipped between two rubber rollers, 1.5 inch (38 mm) in diameter with a 1/16 inch (1.6 mm) gap between rollers of an Atlas Laboratory Wringer type LW-1, made by Atlas Electric Devices Co. (Chicago, Ill.). The nipping pressure was controlled by weights attached to an arm that applies pressure to the top roller. Pressure was applied through iterative nip passes until the desired wet pick up was achieved. Wet pick up and add-on were calculated using the following equations:
% WPU=((W_{W}−W_{D})/W_{D})×100
% Add-on=(% WPU/100)×Bath concentration

Where,

WPU=Wet pick up

W_{W}=Wet weight after saturation/nipping

W_{D}=Dry weight of untreated wiper

Bath concentration=Concentration of wetting agent in bath

TABLE 2
Wetting Agent Add-on

| Example | Wetting Agent | W_{W} (g) | W_{D} (g) | % WPU | % Add-on |
|---|---|---|---|---|---|
| 1 | Surfynol 440 | 12.58 | 5.51 | 128 | 0.64 |
| 2 | Surfynol 485 | 13.23 | 5.343 | 147 | 0.74 |
| 3 | Dynol 604 | 12.42 | 5.912 | 110 | 0.55 |
| 4 | Unithox 490 | 17.1 | 6.95 | 146 | 0.73 |

*Bath concentration = 0.5%

Comparative samples were tested along with the samples of Examples 1-4. The Comparative Example 1 was an untreated, QTC control wiper. Comparative Example 2 was a Texwipe Vectra Alpha 10 wiper, as sold by ITW Texwipe (Mahwah, N.J.). Wipe dry test (Version 1.0) results for the lab treated samples of Examples 1-4 and for Comparative Examples 1 and 2 are shown in Table 3.

TABLE 3
Wipe Dry Test (Version 1.0) Results for Examples 1-4

| | | | | | Comparative | Comparative |
|---|---|---|---|---|---|---|
| | Example 1 | Example 2 | Example 3 | Example 4 | Example 1 | Example 2 |
| MD (cm²) | 166.67 | 50.00 | 75.00 | 75.00 | 0.00 | 0.00 |
| CD (cm²) | 143.75 | 62.50 | 62.50 | 90.00 | 0.00 | 0.00 |

### Examples 5-7

In the same manner as outlined above for Examples 1-4, QTC Control wipers were treated with Repel-o-tex (Example 5), Hydropol (Example 6), and Hydrosystem (Example 7), all obtained from Rhodia, Inc., Cranbury, N.J. The wipers were saturated in various baths in the same manner as in Examples 1-4. All of the wipers of Examples 5-7 were saturated to a 0.5% add-on level. Absorbent capacity (water), vertical wicking and wipe dry results for these hand treated samples are shown in Table 4. Data for Comparative Example 2 (i.e., Texwipe Vectra Alpha 10) is included for comparison.

TABLE 4
Test Results for Examples 5-7

| | | | | | Comparative |
|---|---|---|---|---|---|
| | | Example 5 | Example 6 | Example 7 | Example 2 |
| Absorbent | Absolute | 3.330 | 3.290 | 2.850 | 2.669 |
| Capcity (water) | capacity (g) | | | | |
| | Specific cap. | 2.820 | 2.750 | 2.500 | 2.056 |
| | (g/g) | | | | |
| Vertical Wicking - CD | 15 seconds | 3.200 | 3.100 | 2.967 | 0.200 |
| (cm) | 30 seconds | 4.333 | 4.267 | 3.967 | 0.200 |
| | 45 seconds | 5.133 | 5.033 | 4.567 | 0.200 |
| | 60 seconds | 5.700 | 5.567 | 5.100 | 0.200 |
| Vertical Wicking - | 15 seconds | 2.800 | 3.600 | 2.500 | 0.100 |
| MD (cm) | 30 seconds | 4.000 | 4.600 | 3.467 | 0.133 |
| | 45 seconds | 4.800 | 5.700 | 4.033 | 0.133 |
| | 60 seconds | 5.367 | 6.267 | 4.400 | 0.133 |
| Wipe dry (cm²) | MD | 75.000 | 0.000 | 0.000 | 0.000 |
| | CD | 90.000 | 56.000 | 0.000 | 0.000 |

As can be seen from the testing results for Examples 1-7, as reported in Tables 3 and 4, samples that had been treated with the surfactants of the present invention had better wiping, wicking, and absorbent properties than similar untreated wipers.

### Examples 8-11

Examples 8-11 were all made using the same QTC Control fabric as used in Examples 1-7. The wipers were chemically treated, as detailed in Table 5, in the rinse cycle of the laundering process during the production of the wipers. The chemical surfactants were manually added during the rinse cycle through the same port used for adding detergent during the wash cycle. Chemical add-on was calculated by weight of the wipers. For example, for a 100 lb. load (45.4 kg) of wipers, 8 ounces (227 g) of surfactant would be added to achieve a 0.5% add-on by weight.

The wipers were washed by three rinse cycles, each 40 minutes in duration, with a water temperature of about 130 to 160 degrees F. (54-71 degrees C.). The wipers were then dried in a cleanroom dryer for 20 to 30 minutes at a temperature of about 150 degrees F. (66 degrees C.).

TABLE 5
Summary of Examples 8-11

| Example | Chemical | Add-on (% by weight) |
|---|---|---|
| 8 | Surfynol 440 | 0.06 |
| 9 | Repel-o-tex | 0.06 |
| 10 | Surfynol 485 | 0.06 |
| 11 | Dynol 604 | 0.06 |

Absorbent capacity (water), absorbent capacity (IPA), vertical wicking, water absorbency rate, water intake rate and wipe dry testing results for Examples 8-11 are shown in Table 6. Data for Comparative Examples 1 and 2 (i.e., untreated, QTC Control and Texwipe Vectra Alpha 10) is included for comparison.

TABLE 6
Test Results for Examples 8-11

| | | | | | | Comparative | Comparative |
|---|---|---|---|---|---|---|---|
| | | Example 8 | Example 9 | Example 10 | Example 11 | Example 1 | Example 2 |
| Water Absorbency | seconds | 0.510 | 0.277 | 0.503 | 0.680 | 1.053 | 17.977 |
| Rate | | | | | | | |
| Water Intake Rate | seconds | 1.716 | N/A | 1.781 | 0.956 | N/A | 5.317 |
| Absorbent | Absolute | 3.351 | 2.797 | 3.261 | 3.259 | 2.975 | 2.241 |
| Capacity (IPA) | capacity (g) | | | | | | |
| | Specific cap. | 2.291 | 1.973 | 2.240 | 2.304 | 2.052 | 1.728 |
| | (g/g) | | | | | | |
| Absorbent | Absolute | 3.492 | 3.626 | 3.376 | 3.437 | 3.375 | 2.669 |
| Capacity (water) | Specific cap. | 2.414 | 2.546 | 2.325 | 2.415 | 2.327 | 2.056 |
| Vertical Wicking - | 15 seconds | 3.333 | 3.567 | 3.033 | 3.100 | 2.833 | 0.200 |
| CD (cm) | 30 seconds | 4.533 | 4.833 | 4.067 | 4.400 | 3.867 | 0.200 |
| | 45 seconds | 5.400 | 5.567 | 4.700 | 5.267 | 4.533 | 0.200 |
| | 60 seconds | 6.133 | 6.933 | 5.567 | 5.900 | 4.933 | 0.200 |
| Vertical Wicking - | 15 seconds | 2.333 | 3.800 | 2.600 | 2.833 | 2.933 | 0.100 |
| MD (cm) | 30 seconds | 3.067 | 4.667 | 3.233 | 3.833 | 3.867 | 0.133 |
| | 45 seconds | 3.800 | 5.333 | 3.600 | 4.600 | 4.400 | 0.133 |
| | 60 seconds | 4.500 | 6.333 | 4.133 | 5.133 | 4.900 | 0.133 |
| Wipe dry (cm²) | MD | 300.000 | 200.000 | 0.000 | 0.000 | 0.0000 | 0.000 |
| | CD | 400.000 | 0.000 | 50.000 | 0.000 | 0.0000 | 0.000 |

As can be seen from the testing results for Examples 8-9, as reported in Tables 6, samples that had been treated with the surfactants of the present invention (at lower add-on levels) had better wiping, wicking, and absorbent properties than similar untreated wipers.

### Examples 12-16

Examples 12-16 were produced at Coville, Inc., Winston-Salem, N.C. by the following processing steps.
1. 100% continuous filament polyester yarn is knitted in one of two pique patterns (Swiss or French—see Table 7) on a circular knitting machine
2. Fabric was run through a continuous hot bath where a detergent was added to clean knitting lubricants off the fabric. Scouring temperature was about 110 degrees F. (43 degrees C.) and the speed through the scouring process was 40 yd/min (36.6 m/min).
3. Fabric bleached white with optical.
4. Hydrowick finish applied to enhance wicking/absorption attributes.
5. Sanitized finish applied for antimicrobial attributes.
6. Cationic softener added to enhance hand feel.
7. Fabric is slit open and finished on the tenter frame.
8. Drying heat is applied in the tenter frame at a temperature of approximately 360 degrees F. (182 degrees C.); speed through the tenter is approximately 40 yd/min (36.6 m/min).
9. After exiting the tenter frame, fabric is packaged in plastic wrap and sent to a third party with the ability to cut the wipers into the desired size and sew the edges of the wiper to minimize lint generation.
10. Cut and sewn wipers are then sent to K-C where they are laundered in an ISO class 5 cleanroom.
11. Wash cycle is approximately 40 minutes at a temperature between 130 and 160 degrees F. (54-71 degrees C.).
12. Wipers are then dried at a temperature of 150 degrees F. (66 degrees C.) for 20 to 30 minutes.
13. Once the laundering process is complete, the wipers are doubled bagged in clear PVC anti-static film using a hand sealer.

A summary of the Coville samples is given in Table 7. The control fabric of Example 12 was made as outlined above. Examples 13 through 16 were also made by the process outlined above, but with the omission of process steps 4, 6 and 7.

TABLE 7
Summary of Examples 12-16

| | | Denier/ | Courses/ |
|---|---|---|---|
| Example | Knit Pattern | Filament | Wales |
| 12 | Control (15206) | 75/72 | 64/40 |
| 13 | French (2210) | 70/100 | 60/40 |
| 14 | French, loose stitch | 70/100 | 56/40 |
| | (2222) | | |
| 15 | Swiss (2209) | 70/100 | 60/40 |
| 16 | Swiss, loose stitch | 70/100 | 56/40 |
| | (2221) | | |

Absorbent capacity (water), absorbent capacity (IPA), vertical wicking, water absorbency rate, water intake rate and wipe dry testing results for Examples 12-16 are shown in Table 8. Data for Comparative Example 2 (i.e., Texwipe Vectra Alpha 10) is included for comparison.

TABLE 8
Test Results for Examples 12-16

| | | | | | | | Comparative |
|---|---|---|---|---|---|---|---|
| | | Example 12 | Example 13 | Example 14 | Example 15 | Example 16 | Example 2 |
| Water Absorbency | seconds | 0.660 | 1.027 | 1.143 | 0.557 | 0.400 | 17.977 |
| Rate | | | | | | | |
| Water Intake Rate | seconds | 0.598 | N/A | N/A | N/A | N/A | 5.317 |
| Absorbent Capacity | Absolute | 3.723 | 2.954 | 3.365 | 2.898 | 3.286 | 2.241 |
| (IPA) | capacity (g) | | | | | | |
| | Specific | 2.355 | 1.985 | 2.275 | 1.990 | 2.272 | 1.728 |
| | cap. (g/g) | | | | | | |
| Absorbent Capacity | Absolute | 4.482 | 3.642 | 3.918 | 3.486 | 3.920 | 2.669 |
| (water) | Specific | 2.863 | 2.442 | 2.685 | 2.367 | 2.666 | 2.056 |
| Vertical Wicking - | 15 seconds | 2.867 | 3.133 | 3.500 | 2.567 | 3.500 | 0.200 |
| CD (cm) | 30 seconds | 4.000 | 4.500 | 5.500 | 3.600 | 4.767 | 0.200 |
| | 45 seconds | 4.633 | 5.567 | 5.933 | 4.567 | 5.867 | 0.200 |
| | 60 seconds | 5.333 | 6.133 | 6.200 | 5.333 | 6.500 | 0.200 |
| Vertical Wicking - | 15 seconds | 3.000 | 3.667 | 3.000 | 2.933 | 3.000 | 0.100 |
| MD (cm) | 30 seconds | 4.167 | 4.700 | 5.000 | 3.867 | 5.000 | 0.133 |
| | 45 seconds | 4.967 | 5.700 | 6.000 | 4.733 | 5.933 | 0.133 |
| | 60 seconds | 5.667 | 6.400 | 6.700 | 5.833 | 6.700 | 0.133 |
| Wipe dry (cm²) | MD | 305.000 | 1000.00 | 1000.000 | 1000.00 | 1000.000 | 0.000 |
| | CD | 305.000 | 1000.00 | 1000.000 | 1000.00 | 1000.000 | 0.000 |

As can be seen from the testing results for Examples 12-16, as reported in Table 8, wipers made by the modification of filaments, deniers, courses and wales, as described by the present invention, had better wiping capability than the unmodified comparative wiper.

### Examples 17-24

Additional testing was conducted on Examples 8, 9, and 10. Similarly, four additional Examples were prepared and tested in the same manner: Example 18 was the QTC control fabric treated with Repel-o-tex at a 0.5% add-on level; Example 18 was the QTC control fabric treated with Hydropol at a 0.5% add-on level; Example 19 is the QTC control fabric treated with Unithox 490 at a 0.5% add-on level; Example 20 is the QTC control fabric treated with Surfynol 440 at a 0.5% add-on level.

Samples were also prepared with conventional surfactants at add-on levels comparable to the examples prepared with the surfactants of the present invention. Example 21 was the QTC Control treated with Milease T, from ICI Americas Inc., at a 0.06% add-on level. Example 22 was the same as Example 21, but the Milease T was at a 0.5% add-on level. Example 23 was the QTC Control treated with Synthrapol KB, from Uniqema (New Castle, Del.) at a 0.06% add-on level. Example 24 was the QTC Control treated with Tween 85LM, from Uniqema, at a 0.06% add-on level.

Comparative examples were similarly tested. As before, Comparative Example 2 was a Texwipe Vectra Alpha 10 wiper, as sold by ITW Texwipe (Mahwah, N.J.). Comparative Example 3 was a Milliken Anticon 100 wiper as sold by Milliken & Company (Spartanburg, S.C.). Comparative Example 4 was a Contec Polywipe Light wiper as sold by Contec Inc. (Spartanburg, S.C.). Comparative Example 5 was a Berkshire UltraSeal 3000 wiper as sold by Bershire Corporation (Great Barrington, Mass.).

All of the samples were tested with the improved Wipe Dry Test (Version 2.0) apparatus and methodology. Additionally vertical wicking, absorbent capacity and dynamic wiping efficiency was tested for each Example. The testing results are summarized in Tables 9, 10, and 11.

TABLE 9

| | | | Example | Example | Example | | Example | Example |
|---|---|---|---|---|---|---|---|---|
| | | Example 9 | 17 | 18 | 19 | Example 8 | 20 | 10 |
| Add-on | % | 0.06 | 0.5 | 0.5 | 0.5 | 0.06 | 0.05 | 0.06 |
| Absorbent | Absolute | 3.626 | 3.720 | 3.230 | 3.568 | 3.492 | 3.470 | 3.376 |
| capacity | capacity | | | | | | | |
| (water) | (g) | | | | | | | |
| | Specific | 2.546 | 2.550 | 2.210 | 2.455 | 2.414 | 2.310 | 2.325 |
| | capacity | | | | | | | |
| | (g/g) | | | | | | | |
| Vertical | 15 sec | 3.567 | 4.000 | 3.600 | 3.333 | 3.333 | 3.800 | 3.033 |
| Wicking - | 30 sec | 4.833 | 5.800 | 4.800 | 4.500 | 4.533 | 5.000 | 4.067 |
| CD (cm) | 45 sec | 5.567 | 6.767 | 5.800 | 5.267 | 5.400 | 5.900 | 4.700 |
| | 60 sec | 6.933 | 7.400 | 6.400 | 6.033 | 6.133 | 6.600 | 5.567 |
| Vertical | 15 sec | 3.800 | 4.000 | 3.700 | 3.500 | 2.333 | 3.500 | 2.600 |
| Wicking - | 30 sec | 4.667 | 5.500 | 4.900 | 4.500 | 3.067 | 4.800 | 3.233 |
| MD (cm) | 45 sec | 5.333 | 6.500 | 5.800 | 5.500 | 3.800 | 5.600 | 3.600 |
| | 60 sec | 6.333 | 7.500 | 6.500 | 6.100 | 4.500 | 6.200 | 4.133 |
| Wipe dry, | cm² | 817 | 990 | 891 | 869 | 753 | 961 | 793 |
| V2.0 | | | | | | | | |
| Dynamic | % | 93 | 96 | 94 | 94 | 95 | 97 | 94 |
| Wiping | | | | | | | | |
| Efficiency | | | | | | | | |

TABLE 10

| | | Example | Example | Example | Example |
|---|---|---|---|---|---|
| | | 21 | 22 | 23 | 24 |
| Add-on | % | 0.06 | 0.5 | 0.06 | 0.06 |
| Absorbent capacity | Absolute | 3.311 | 3.323 | 3.436 | 3.177 |
| (water) | capacity (g) | | | | |
| | Specific | 2.351 | 2.316 | 2.386 | 2.271 |
| | capacity | | | | |
| | (g/g) | | | | |
| Vertical Wicking - CD | 15 seconds | 2.600 | 4.000 | 2.267 | 2.200 |
| (cm) | 30 seconds | 3.700 | 5.500 | 3.200 | 3.500 |
| | 45 seconds | 4.400 | 6.267 | 3.967 | 4.133 |
| | 60 seconds | 5.000 | 7.067 | 4.667 | 4.700 |
| Vertical Wicking - MD | 15 seconds | 2.300 | 4.000 | 1.033 | 2.000 |
| (cm) | 30 seconds | 3.233 | 5.267 | 1.900 | 2.833 |
| | 45 seconds | 4.100 | 5.933 | 2.700 | 3.500 |
| | 60 seconds | 4.700 | 6.767 | 3.167 | 3.967 |
| Wipe dry, V2.0 | cm² | 807 | 971 | 790 | 751 |
| Dynamic Wiping | % | 93 | 92 | 95 | 85 |
| Efficiency | | | | | |

TABLE 11

| | | Comparative | Comparative | Comparative | Comparative |
|---|---|---|---|---|---|
| | | Example 2 | Example 3 | Example 4 | Example 5 |
| Absorbent | Absolute | 2.669 | 3.886 | 2.327 | 4.530 |
| capacity | capacity (g) | | | | |
| (water) | Specific | 2.056 | 3.489 | 2.015 | 3.213 |
| | capacity | | | | |
| | (g/g) | | | | |
| Vertical | 15 seconds | 0.200 | 2.500 | 2.800 | 3.900 |
| Wicking - CD | 30 seconds | 0.200 | 3.333 | 3.667 | 5.000 |
| (cm) | 45 seconds | 0.200 | 3.967 | 4.133 | 5.633 |
| | 60 seconds | 0.200 | 4.500 | 4.567 | 6.033 |
| Vertical | 15 seconds | 0.100 | 2.633 | 3.000 | 3.800 |
| Wicking - MD | 30 seconds | 0.133 | 3.400 | 3.967 | 4.933 |
| (cm) | 45 seconds | 0.133 | 4.267 | 4.533 | 5.667 |
| | 60 seconds | 0.133 | 4.533 | 5.233 | 6.233 |
| Wipe dry, V2.0 | cm² | 709 | 833 | 824 | 760 |
| Dynamic | % | 88 | 90 | 88 | 91 |
| Wiping | | | | | |
| Efficiency | | | | | |

As shown in Tables 9, 10 and 11, the Examples using the surfactants of the present invention demonstrated desired wipe dry testing results with add-on levels of 0.06 and 0.5 percent. The wipe dry capability, using the improved wipe dry test (version 2.0), was greater than 760 cm² for the majority of the Examples using the surfactants of the present invention with most of the codes having a wipe dry capability greater than 860 cm². Additionally, the wipe dry capability is directionally confirmed by the dynamic wiping efficiency which was greater than 91 percent for all of the Examples tested having the surfactants of the present invention.

The Examples using the surfactants of the present invention had better wipe dry capability (using the wipe dry test, version 2.0), vertical wicking and dynamic wiping efficiency than the Comparative Examples. The wipe dry testing, using the improved wipe dry test (Version 2) directionally showed the same results as shown with the previously used wipe dry test (Version 1.0).

Additionally, some of the Examples using the surfactants of the present invention had better wipe dry capability, vertical wicking and dynamic wiping efficiency than the Examples made with conventional surfactants. Two of the Examples (Example 21 and 22) using a conventional surfactant (Milease T) had good wipe dry values. However, particle and extractable ion testing showed that these Examples made with conventional surfactants either had higher particle counts or higher extractable ions than either the Examples made with the surfactants of the present invention or the Comparative Examples. A summary of particle, extractable ion and pore size distribution testing for the Examples using surfactant is shown in Table 12. A summary of these same tests done on the Comparative Examples is shown in Table 13.

TABLE 12

| | Example | Example | Example | Example |
|---|---|---|---|---|
| | 17 | 20 | 21 | 22 |
| Particles by biaxial shake | 31.12 | 8.92 | | 54.36 |
| (particles/m² × 10⁶) | | | | |
| Extractable Na ions(ppm) | 0.4370 | 0.3420 | 1.0200 | |
| Extractable K ions(ppm) | 0.3430 | 0.1520 | 0.9330 | |
| Extractable Cl ions(ppm) | 0.5690 | 0.1420 | 0.4020 | |
| % of Pores 0-20 micron | 14.39 | 8.19 | | |
| % of Pores 0-40 micron | 31.19 | 17.06 | | |
| % of Pores | 43.88 | 48.76 | | |
| 60-160 micron | | | | |

TABLE 13

| | Compar- | Compar- | Compar- | Compar- |
|---|---|---|---|---|
| | ative | ative | ative | ative |
| | Example 2 | Example 3 | Example 4 | Example 5 |
| Particles by biaxial shake | 4.17 | 7.1 | 65 | 12 |
| (particles/m² × 10⁶) | | | | |
| Extractable Na | 0.151 | 0.19 | 8 | 0.049 |
| Ions (ppm) | | | | |
| Extractable K Ions (ppm) | 0.117 | 0.08 | N/A | 0.036 |
| Extractable | 0.161 | 0.24 | 3 | 0.009 |
| Cl Ions (ppm) | | | | |
| % of Pores 0-20 micron | 0.00 | 1.44 | 8.32 | 9.34 |
| % of Pores 0-40 micron | 3.94 | 2.16 | 12.44 | 19.37 |
| % of Pores 60-160 | 6.01 | 2.16 | 30.08 | 47.54 |
| micron | | | | |

As can be seen in Tables 12 and 13, the Examples illustrating the wiper of the present invention and having the desired level of wipe dry capability, also has the desired pore size distribution. Namely, a greater percentage of pores having a size less than 20 microns are present than found in the Comparative Examples. As is preferred for the wipers of the present invention, there are between 5 and 25 percent of the pores are of a size less than 20 microns and between 30 and 50 percent of the pores of a size range between 60 and 160 microns.

The wipers of Examples 12-16 were also tested using the improved wipe dry test. Additionally, dynamic wiping efficiency, vertical wicking, absorbent capacity, pore size distribution testing, particles, and extractable ions were also tested for each of Examples 12-16. A summary of the testing results is given in Table 14.

TABLE 14

| | | Example | Example | Example | Example | Example |
|---|---|---|---|---|---|---|
| | | 12 | 13 | 14 | 15 | 16 |
| Absorbent | Absolute | 4.482 | 3.642 | 3.918 | 3.486 | 3.920 |
| capacity | capacity (g) | | | | | |
| (water) | Specific | 2.863 | 2.442 | 2.685 | 2.367 | 2.666 |
| | capacity | | | | | |
| | (g/g) | | | | | |
| Vertical | 15 seconds | 2.867 | 3.133 | 3.500 | 2.567 | 3.500 |
| Wicking - CD | 30 seconds | 4.000 | 4.500 | 5.500 | 3.600 | 4.767 |
| (cm) | 45 seconds | 4.633 | 5.567 | 5.933 | 4.567 | 5.867 |
| | 60 seconds | 5.333 | 6.133 | 6.200 | 5.333 | 6.500 |
| Vertical | 15 seconds | 3.000 | 3.667 | 3.000 | 2.933 | 3.000 |
| Wicking - MD | 30 seconds | 4.167 | 4.700 | 5.000 | 3.867 | 5.000 |
| (cm) | 45 seconds | 4.967 | 5.700 | 6.000 | 4.733 | 5.933 |
| | 60 seconds | 5.667 | 6.400 | 6.700 | 5.833 | 6.700 |
| Wipe dry, | cm² | 779 | 970 | 990 | 985 | 988 |
| V2.0 | | | | | | |
| DWE | % | | 93 | 87 | 92 | 93 |
| % of Pores 0-20 | % | 24.53 | 23.15 | 26.06 | 24.14 | 25.11 |
| micron | | | | | | |
| % of Pores 0-40 | % | 43.05 | 36.58 | 43.90 | 35.67 | 41.05 |
| micron | | | | | | |
| % of Pores | % | 32.48 | 36.32 | 27.74 | 43.03 | 34.25 |
| 60-160 micron | | | | | | |
| Particles by | particles/ | | 20.4 | | 15.5 | |
| biaxial shake | m² × 10⁶ | | | | | |
| Extractable | ppm | | 2.260 | | 0.376 | |
| Na ions | | | | | | |
| Extractable K | ppm | | 0.098 | | 0.117 | |
| ions | | | | | | |
| Extractable Cl | ppm | | 2.690 | | 1.080 | |
| ions | | | | | | |

As previously discussed, the wipers of Examples 12-16 were produced using the fabric modification methods of the invention to achieve the desired pore size distribution of the invention and subsequently the desired wipe dry capability. As can be seen from the results in Table 14, the modified structures of Examples 13-16 had better wipe dry and wicking properties compared to the control fabric (Example 12). Additionally, as expected the looser stitch wipers (Examples 14 and 16) had better wipe dry and wicking capability compared to the corresponding tighter stitch wipers (Examples 13 and 15).

We claim:

1. A wiper for use in a cleanroom environment comprising;
a knitted substrate of continuous, synthetic filaments, where the substrate has a surface and where the substrate is suitable for use in a cleanroom environment, and
a surfactant present on the surface of the knitted substrate, where the surfactant is selected from the group consisting of gemini surfactants, polymeric wetting agents, and functionalized oligomers.

2. The wiper of claim 1, where the surfactant is present in an add-on amount of about 0.5 percent or less, by weight of the knitted substrate.

3. The wiper of claim 2, where the surfactant is present in an add-on amount between about 0.06 percent and 0.5 percent, by weight of the knitted substrate.

4. The wiper of claim 3, where wiper has a vertical wicking capability at 60 seconds of about 5 centimeters or greater.

5. The wiper of claim 4, where the wiper has a wipe dry capability of about 760 square centimeters or greater.

6. The wiper of claim 4, where the wiper has a dynamic wiping efficiency of about 91 percent or greater.

7. The wiper of claim 3, where the wiper has a wipe dry capability of about 760 square centimeters or greater.

8. The wiper of claim 1, where the knitted substrate comprises continuous polyester filaments.

9. The wiper of claim 1, where the surfactant is a gemini surfactant.

10. The wiper of claim 1, where the wiper has an extractable ion content of less than about 0.5 parts per million of Na ions, less than about 0.5 parts per million of K ions, and less than about 0.5 parts per million of Cl ions.

11. The wiper of claim 1, where the wiper has about 30×10⁶ particles per square meter or less, by the Biaxial Shake Test (IEST RP-CC004.3, Section 6.1.3).

12. The wiper of claim 1, where the wiper has a knitted structure with a pore size distribution where about 5 to about 25 percent of the pores are of a size of about 20 microns or less, and where about 30 to about 50 percent of the pores are of a size in the range from about 60 microns to about 160 microns.

13. A wiper for use in a cleanroom environment comprising;
a knitted substrate of continuous, synthetic filaments, where the substrate has a surface and where the substrate is suitable for use in a cleanroom environment, and
where the wiper has a wipe dry capability of about 850 square centimeters or greater.

14. The wiper of claim 13, where a surfactant present on the surface of the knitted substrate and the surfactant is selected from the group consisting of gemini surfactants, polymeric wetting agents, and functionalized oligomers.

15. The wiper of claim 13, where wiper has a vertical wicking capability at 60 seconds of about 5 centimeters or greater.

16. The wiper of claim 13, where the wiper has a dynamic wiping efficiency of about 91 percent or greater.

17. The wiper of claim 13, where the knitted substrate comprises continuous polyester filaments.

18. The wiper of claim 13, where the wiper has an extractable ion content of less than about 0.5 parts per million of Na ions, less than about 0.5 parts per million of K ions, and less than about 0.5 parts per million of Cl ions, and where the wiper has about 30×10⁶ particles per square meter or less, by the Biaxial Shake Test (IEST RP—CC004.3, Section 6.1.3).

19. The wiper of claim 13, where the wiper has a knitted structure with a pore size distribution where about 5 to about 25 percent of the pores are of a size of about 20 microns or less, and where about 30 to about 50 percent of the pores are of a size in the range from about 60 microns to about 160 microns.

20. A wiper for use in a cleanroom environment comprising;
a knitted substrate of continuous, polyester filaments, where the substrate has a surface and where the substrate is suitable for use in a cleanroom environment, and
a surfactant present on the surface of the knitted substrate, where the surfactant is selected from the group consisting of gemini surfactants, polymeric wetting agents, and functionalized oligomers,
where the wiper has an extractable ion content of less than about 0.5 parts per million of Na ions, less than about 0.5 parts per million of K ions, and less than about 0.5 parts per million of Cl ions, and
where the wiper has about 30×10⁶ particles per square meter or less, by the Biaxial Shake Test (IEST RP-CC004.3, Section 6.1.3).

21. The wiper of claim 20, where the surfactant is present in an add-on amount of about 0.5 percent or less, by weight of the knitted polyester substrate.

22. The wiper of claim 21, where the surfactant is present in an add-on amount between about 0.06 percent and 0.5 percent, by weight of the knitted polyester substrate.

23. The wiper of claim 20, where wiper has a vertical wicking capability at 60 seconds of about 5 centimeters or greater.

24. The wiper of claim 20, where the wiper has a wipe dry capability of about 850 square centimeters or greater.

25. The wiper of claim 20, where the wiper has a dynamic wiping efficiency of about 91 percent or greater.

26. The wiper of claim 20, where the wiper has a knitted structure with a pore size distribution where about 5 to about 25 percent of the pores are of a size of about 20 microns or less, and where about 30 to about 50 percent of the pores are of a size in the range from about 60 microns to about 160 microns.
